(19) United States
(12) Patent Application Publication
(10) Pub. No.: US 2007/0022667 A1
(43) Pub. Date: Feb. 1, 2007

(54) Product display case door frame having an integrated raceway

(75) Inventor: Kent Olofsson, Charlottenberg (SE)

Correspondence Address: Vincent L. Ramik;DILLER, RAMIK & WIGHT, Suite 101, 7345 McWhorter Place, Annandale, VA, 22003, US

(73) Assignee: Gemtron Corporation

(21) Appl. No.: 11/190,907

(22) Filed: Jul. 28, 2005

(51) Int. Cl. E06B 1/04

(52) U.S. Cl. 49/504

(57) ABSTRACT

An illuminated refrigerated display cabinet having a refrigerated product compartment includes a door frame defining an integrated raceway extending along a horizontal upper portion of the door frame. Electrical ballast associated with florescent tubes are mounted in a raceway chamber of the raceway and are accessible through a movable raceway chamber access door. The raceway chamber can be accessed without opening doors accessing the refrigerated product compartment thereby eliminating cold air losses, increasing efficiency and lowering operating costs.

### BACKGROUND OF THE INVENTION

This invention is directed to product display cabinets or cases which are used in self-service markets, stores and other establishments in which products are illuminated, viewed, selected and purchased.

The invention is particularly directed to refrigerated display cases or cabinets which are operated below external ambient temperature. Typically, such display cabinets include one or more insulated glass doors through which products, such as ice cream, yogurt or the like, on shelves in an interior refrigerated compartment can be viewed, selected and removed. In a perfect world a consumer would view all products through the closed glass doors, reach a decision as to which product is to be removed prior to opening the door, thereafter quickly open the door, remove the product and promptly close the door. The latter efficient procedure limits the escape of cold air, reduces glass “fogging” (condensation) and reduces the overhead of electricity costs which normally power fans and compressors associated with conventional refrigeration systems. More typically consumers are observed standing in front of refrigerated display cases holding the door or doors thereof open while viewing, selecting and removing a desired product. The longer a door is held open, the more expensive are the marketing costs associated therewith.

Presently, most product display cabinets are illuminated by florescent tubes which do not generate the magnitude of heat associated with incandescent lighting systems, and presently the trend appears to be that of moving away from florescent lighting to LED's. Irrespective of the particular lighting system involved, the same must be provided at substantially low manufacturing, installation, retrofitting, replacement, repair, maintenance and electrical energy costs. The replacement of florescent tubes/lamps requires the opening of display cabinet doors which in turn allows the escape of a considerable amount of cold air. More significant cold air loss is attributed to the replacement of electrical components, such as ballasts, which are accessible only with the display doors being open or with the ballast being accessible only from the cold side/refrigerated product compartment of conventional display cases.

Typical cold-side accessible ballasts associated with refrigerated display cases are found in U.S. Pat. Nos. 5,720,540 and 6,010,227 granted respectively on Feb. 24, 1998 and Jan. 4, 2000.

U.S. Pat. No. 5,645,330 granted on Jul. 8, 1997 discloses ballasts mounted in so-called mullions of display case door frames which necessitate maintaining the display door open during testing, repair and/or replacement of an associated ballast.

U.S. Pat. No. 6,298,615 granted on Oct. 9, 2001 is an example of a frame for use with a refrigerated display case defined by top, bottom and side frame members, as well as mullions between the latter, each being formed individually as a forward-facing or forward-opening raceway in which can be accommodated power transmission wires, lamp ballast and any other electrical hardware and couplings utilized in the door frame. This construction of forwardly opening unobstructed raceways is said to ease the assembly of the frame and wires and the maintenance and repair thereof, including lamp ballasts housed in forwardly opening channels of the vertical mullions. However, the channels of all of the forward facing raceways are closed by a metal contact plate against which seals a gasket carried by the display door with which is also associated a peripheral magnet whose magnetic attraction with respect to the contact plate holds the gasket sealed thereto. Therefore, though power transmission wires, heating wires, ballast and the like can be readily assembled into the forwardly facing raceways during manufacture, replacement of any of the components within the raceways requires the display door associated therewith to be opened and connector strips removed to disassemble the contact plate of a particular raceway to expose the channel thereof. During subsequent component inspection, repair and replacement the display door is necessarily maintained in an open position which maximizes the loss of cold air and proportionately increases operating costs associated therewith.

### SUMMARY OF THE INVENTION

The present invention is directed to a display cabinet which is internally illuminated utilizing florescent tubes, though the invention may equally be utilized in conjunction with LED's, fiber optic lighting or the like. The display cabinet includes a conventionally refrigerated product compartment having a forward door frame defining a product access opening into the product compartment which can be opened and closed by a sliding or pivoted display door typically utilizing a convention IG (insulated glass) unit. The door frame includes at least upper, lower and side frame members, each of which defines an integrated raceway opening forwardly or toward the warm side of the display cabinet. One or more vertical mullions may also be utilized to divide the access area of the display cabinet into a plurality of access openings, each accessible through an associated display door. Each of the vertical mullions can also include an integrated raceway. Electrical wiring, such as power transmission wires for florescent tubes and electrical heating wires can be located in the integrated raceways, as well as electrical ballast for the florescent tubes which are preferably located in an upper substantially horizontally disposed forwardly/warm-side opening raceway. One or more electrical ballasts can be located in the upper horizontally disposed raceway which is preferably selectively opened and closed by a cover. Most importantly and significant to the invention herein is the fact that the cover for providing access into the raceway can be opened or closed when the display door(s) is in its closed position closing the product access opening into the refrigerated compartment thereby reducing cold air losses, increasing inefficiency and correspondingly decreasing expenses. The electrical ballast can be inspected and/or tested by a repair person without opening the display door and without maintaining a display door open during ballast access, inspection, testing, repair and/or replacement.

In further accordance with the present invention, the cover for opening and closing the opening of the raceway to gain access to an interior chamber thereof housing the electrical ballast is preferably pivotally mounted to one edge of the raceway while an opposite edge of the cover can be secured to the raceway to preclude inadvertent, unintentional or accidental access to the raceway chamber and its electrical components to preclude personal injury (electrical shock).

The chamber of the integrated raceway also includes a track along which one or more ballasts can be adjustably secured to facilitate maintenance, particularly replacing a variety of ballasts of different manufacturers.

With the above and other objects in view that will hereinafter appear, the nature of the invention will be more clearly understood by reference to the following detailed description, the appended claims and the several views illustrated in the accompanying drawings.

### BRIEF DESCRIPTION OF THE DRAWINGS

FIG. 1 is a fragmentary front perspective view, and illustrates a display cabinet including a plurality of glass paneled display doors, a door frame and three electrical ballasts located in an upper raceway chamber of an upper horizontally disposed forward opening integrated raceway of the door frame closed by a cover.

FIG. 2 is an enlarged fragmentary cross-sectional view taken generally along line 2-2 of FIG. 1, and illustrates details of the integrated door frame raceway, the display door, a product access opening defined by the frame, and one of a plurality of florescent lamps or tubes electrically connected to one of the ballasts.

FIG. 3 is an enlarged fragmentary cross-sectional view taken generally along line 3-3 of FIG. 1, and illustrates the manner in which a florescent lamp is located vertically along a vertical end frame of the door frame and a magnet holding a door gasket sealed against a metal contact plate in a closed position of the door.

FIG. 4 is an enlarged fragmentary cross-sectional view taken generally along line 4-4 of FIG. 1, and illustrates the manner in which a florescent tube is carried by a vertical mullion of the door frame and additional door gaskets sealed by magnets to contact plates in the closed position of the display doors.

FIG. 5 is an enlarged fragmentary front elevational view of the encircled portion of FIG. 1, and illustrates an electrical ballast mounted in the raceway chamber.

FIG. 6 is an enlarged fragmentary perspective view, and illustrates details of the integrated raceway, a track thereof and the manner in which the electrical ballast is secured to the track.

FIG. 7 is an enlarged fragmentary cross-sectional view similar to the upper portion of FIG. 2, and illustrates details of the integrated raceway and a cover thereof in the closed and locked position.

### DESCRIPTION OF THE PREFERRED EMBODIMENTS

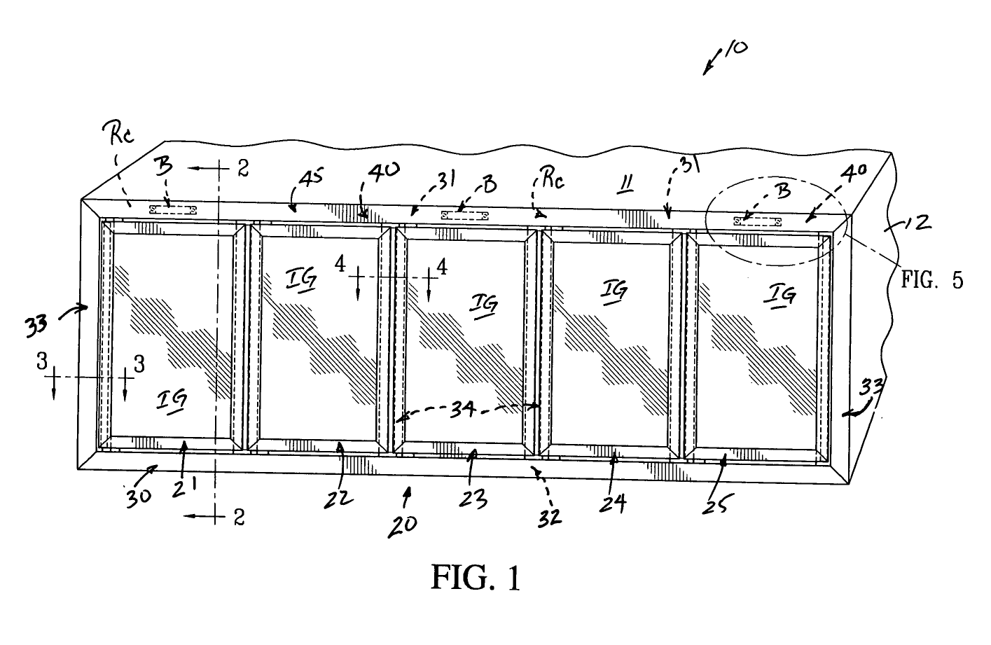

An illuminated refrigerated display cabinet, case, walk-in or the like is illustrated in FIG. 1 of the drawings, and is generally designated by the reference numeral 10.

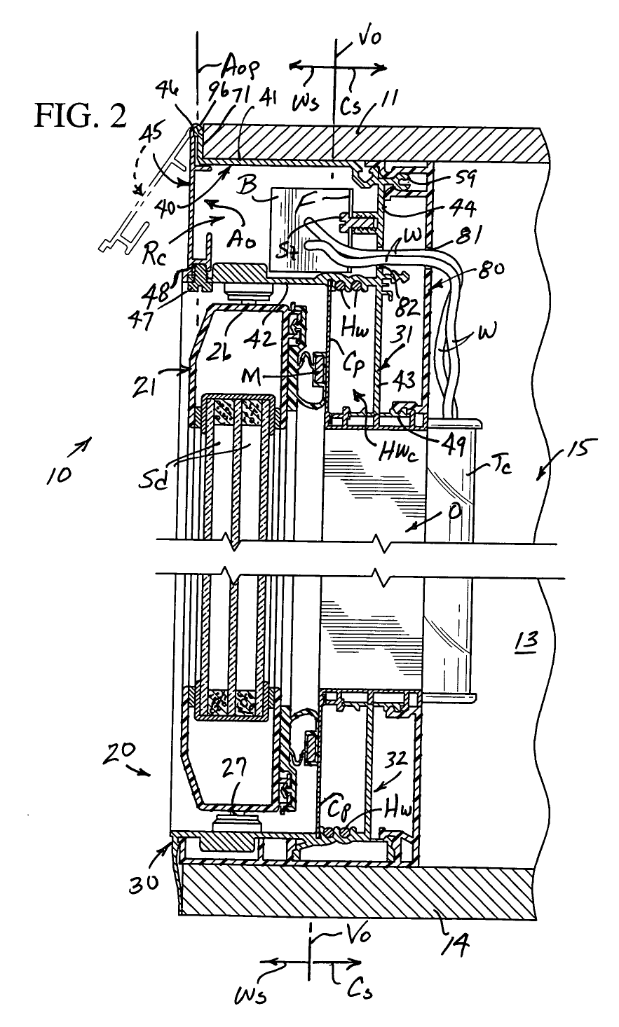

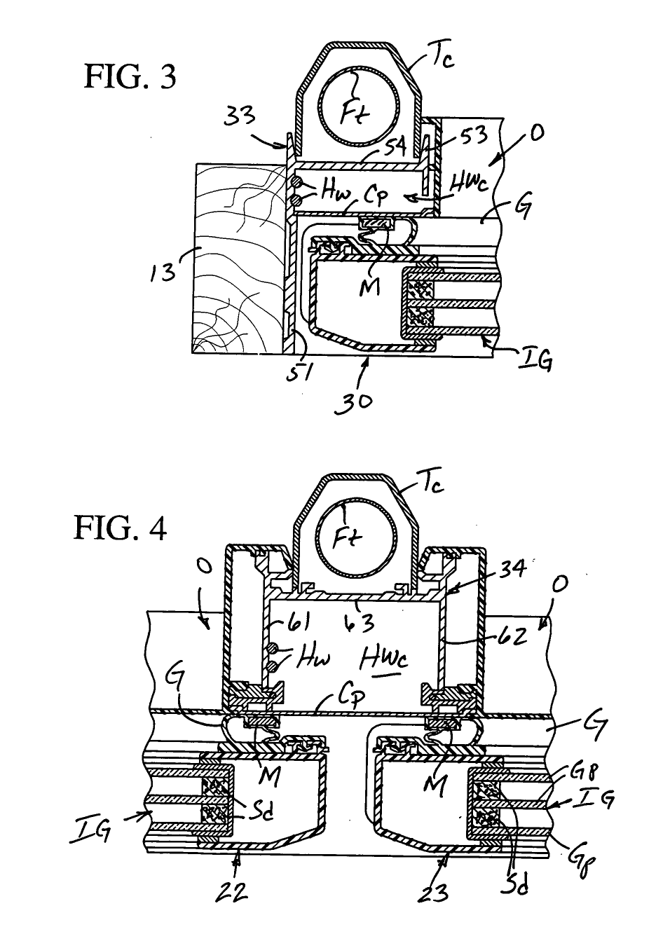

The display cabinet 10 may be, for example, a self-contained refrigerated unit which, after manufacture, is shipped to a self-service market, store or like establishment in which perishable food items are stored on shelves (not shown) or the display cabinet 10 can be a so-called built-in by which the cabinet 10 can be framed-out at the use site. In either case the display cabinet 10 includes a top wall 11 (FIGS. 1 and 2), opposite substantially parallel side walls 12, 13 (FIGS. 1 and 2, respectively), a bottom wall 14 (FIG. 2) and a rear wall (not shown) collectively defining an interior refrigerated product compartment 15 (FIG. 2) which is kept substantially below outside ambient temperature by a conventional cooling system (not shown). A front of the display cabinet 10 includes a door frame and door assembly 20. The door frame and door assembly 20 includes a door frame 30 and a plurality of conventional IG display doors 21 through 25 (FIG. 1), each of which includes upper and lower vertical pivots 26, 27 (FIG. 2) for pivoting each door 21 through 25 to respective upper and lower horizontal extruded metal frame members 31, 32 (FIG. 2) of the door frame 30 which also includes vertical extruded metal end frame members 33 of which one is illustrated in FIG. 3 and four substantially identical vertical extruded metal mullions or frame members 34, one of which is illustrated in detail in FIG. 4 of the drawings. Inboardmost walls (unnumbered) of the frame members/mullions 31-34 set-off five access openings O, one opening O associated with each display door 21-25, through which products in the refrigerated compartment 15 can be viewed and accessed.

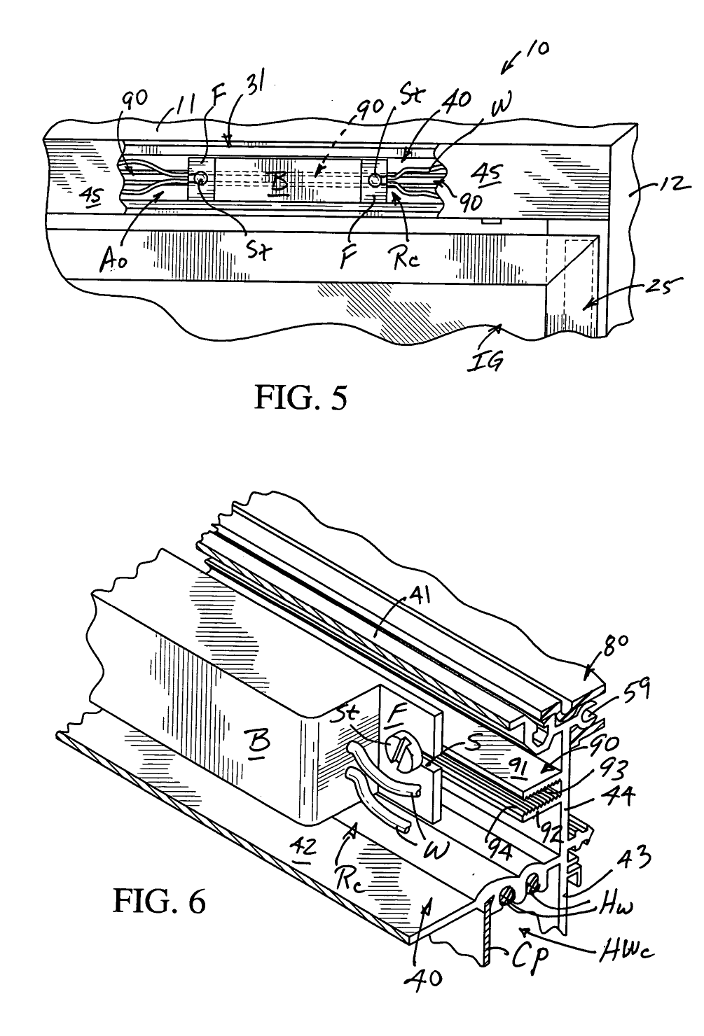

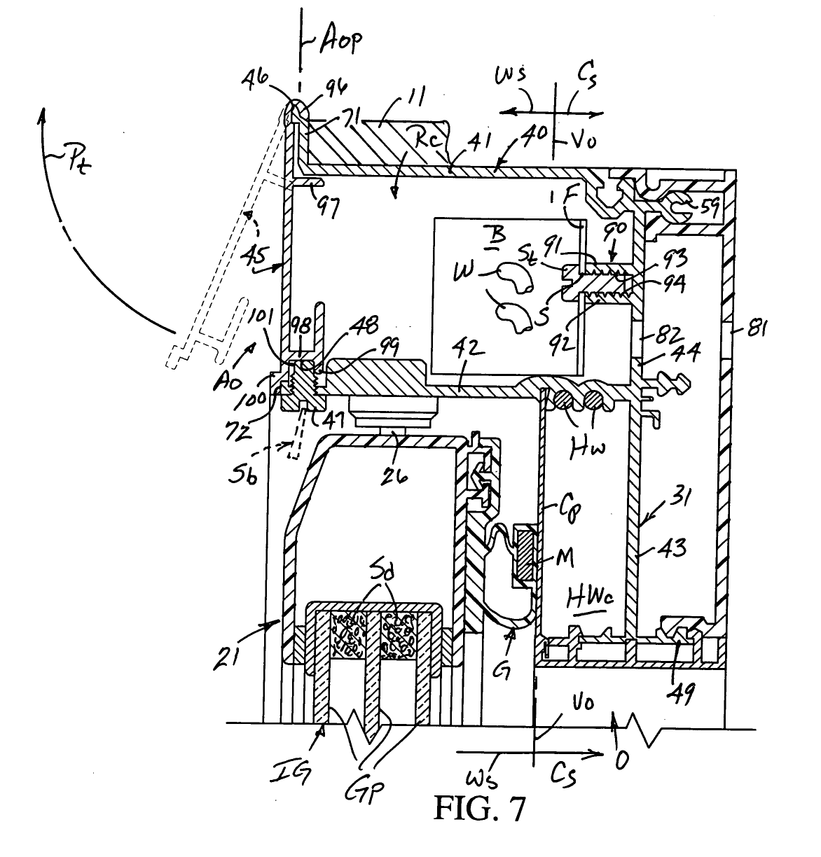

The upper frame member 31 of the door frame 30 defines an integrated raceway 40 (FIGS. 2 and 5) which extends along the entire length of the display cabinet 10 between the side walls 12, 13 and is defined by an upper wall 41, a lower wall 42 and an upper portion 44 of a rear wall 43 (FIG. 2). The walls 41, 42 define a front access opening Ao opening into a raceway chamber Rc of the raceway 40 extending the length of the upper frame member 31 between the side walls 12, 13 which can be accessed from the front of the display cabinet 10 by pivoting a raceway chamber access door 45 between the positions shown in phantom outline in FIG. 7 about an upper pivot point or edge 46 of the upper raceway wall 41 upon the removal of one or more locking screws 47 (FIGS. 2 and 7) which are each received in a downwardly opening channel 48 (FIG. 7) of the cover 45.

The opposite vertical end frame members 33 (FIG. 3) of the frame 30 are each of an identical construction and are defined by a vertical outboard side wall 51, an inboard vertical side wall 53 and a web 54 spanning the side walls 51, 53. A conventional metal contact plate Cp encloses a heating wire chamber HWc in which are located conventional heating wires Hw. Rearward of the web 54 is a conventional florescent tube Ft disposed substantially vertically in a conventional manner and being connected by wires W (FIG. 2) to a source of electrical energy (not shown) to effectively illuminate the product compartment 15. A translucent cover Tc conventionally supported by the vertical end frame members 33 disperses light from the florescent tube Ft into the refrigerated food compartment 15.

The vertical mullions 34 (FIG. 4) are each of a generally H-shaped transverse cross-sectional configuration, and include opposite vertical substantially parallel walls 61, 62 spanned by a web 63. As in the case of the vertical end members 33, each of the vertical mullions 34 include a metal contact plate Cp inboard of which are heating wires Hw in a heating wire chamber HWc and outboard of the web 63 is a vertical florescent tube or lamp Ft enclosed by a translucent cover Tc.

Each of the doors 21-25 includes an insulated glass unit IG defined by three glass panels Gp separated by desiccant embedded warm technology spacers Sd, and inboard thereof a peripheral gasket G which includes a peripheral hollow interior chamber (unnumbered) housing a magnet or magnetically material M (FIG. 7). In the closed position of the doors 21-25 the magnetic attraction of the magnetic material M holds each of the gaskets G in intimate sealing engagement with the associated contact plates Cp which close the heating wire chambers HWc and peripherally border each opening O, as is most readily apparent from FIGS. 2 through 4 of the drawings. Obviously, the doors 21-25 can be readily opened against the magnetic force of the magnets M to access the products (not shown) within the refrigerated product compartment 15 through the openings O thereof. As is most readily apparent from FIG. 2 of the drawings, when the doors 21 through 25 are closed, the interior of the heating wire compartments HWc housing the heating wires Hw are inaccessible and in order to access the same for any reason whatever, the associated door 21-25 must be opened, the contact plate Cp associated therewith removed, and during such procedure, cold air from the refrigerated product compartment 15 escapes through the associated product access opening O to atmosphere (“warm side”).

As is also most readily apparent from FIGS. 2 and 7 of the drawings, the raceway chamber Rc of the integrated raceway 40 is located above the heating wire compartment HWc and the access opening Ao (FIG. 7) thereof is defined by a plane Aop substantially through an upper outwardly directed vertical flange 71 of the upper raceway wall 41 and an outboard edge 72 of the lower raceway wall 42. The raceway chamber Rc is located substantially outboard of the “cold side” Cs (FIG. 7) and well into the “warm side” Ws of the refrigerator compartment 15. A vertical plane Vo (FIGS. 2 and 7) defines a plane of demarcation between the warm side Ws and the cold side Cs of the refrigerator product compartment 15 which is located substantially in the sealing plane of the contact plates Cp and the gaskets G. A similar vertical plane Aop through the access opening Ao of the raceway chamber Rc is located well outside (to the left in FIGS. 2 and 7) of the vertical plane Vo and the doors 21-25, as well as well above the doors 21-25.

A plastic material cover plate 80 (FIGS. 2 and 7) is snap-secured to a lower flange 49 and an upper protuberance 59 in the manner clearly apparent in FIGS. 2 and 7 of the drawings. The wires W (FIG. 2) pass through an opening 81 of the cover plate 80 and another aligned opening 82 formed in the upper portion 44 of the rear wall 43 of the raceway 40. The wires W are connected to each of several conventional electrical florescent lamp ballasts B (FIGS. 6 and 7) which include oppositely directed flanges F having slots S opening oppositely outwardly therefrom. Means 90 in the form of an elongated channel defined by upper and lower walls 91, 92, respectively, is provided in the raceway chamber Rc for securing one or more ballast B therein. Each of the walls 91, 92 has a plurality of substantially parallel grooves 93, 94, respectively, into which threaded screws St can be threaded to appropriately locate the ballast B therein (FIG. 6).

As was heretofore noted, in order to access the raceway chamber Rc, the raceway chamber access door or cover 45 need but be pivoted about the pivot 46 along a path of travel Pt to the full open position beyond that shown in phantom outline in FIG. 7 to fully open the raceway chamber access opening Ao. In order to accommodate the pivoting movement of the raceway chamber access cover 45, an upper end portion thereof is formed as a downwardly opening hook 96 which can be slipped downwardly upon or upwardly from the upper edge 46 of the flange 71 of the upper wall 41 of the raceway 40. Immediately below the hook 96 is an inwardly directed flange 97 and spaced therebeneath is another inwardly directed flange 98 having a downwardly directed edge 99 spaced from a stepped terminal edge 100 of the access cover 45. The flange 98, edge 99 and stepped bottom edge 100 define the elongated channel 48 into which the screw 47 can be threaded or unthreaded. When sufficiently unthreaded and/or removed, the screw 47 permits the raceway chamber access door 45 to be opened and closed (phantom outline in FIG. 7) but when threaded “home,” as shown in solid lines in FIG. 7, the raceway access door 45 cannot be opened. Each screw 47 can be accessed from beneath by a screwdriver blade Sb (FIG. 7) or similar tool and thus none of the doors 21-25 need be opened to open the raceway chamber access door 45. Therefore, as is best illustrated in FIGS. 2 and 7 of the drawings, if no light is generated from one or more of the florescent lamps Ft and one of the ballast B is suspect, the screws 47 appropriately located along the length of the raceway chamber access door 45 can be unthreaded/removed and the door 45 can be pivoted from the solid to and beyond the phantom outline position shown in FIG. 7 to gain access to one or all of the ballasts B through the raceway chamber access opening Ao, check the same and repair/replace the ballast B as necessary. It is to be particularly noted that the latter can be accomplished absent any of the doors 21-25 being opened thereby precluding the escape of cold air from the warm side Ws of the refrigerated product compartment 15 to the exterior thereof through the obviously closed product compartment access openings O. Thus the forwardly opening raceway chamber Rc located above and well outboard of the vertical plane Vo affords rapid and low cost maintenance of the ballasts B or any wiring associated therewith running in and along the length of the raceway chamber Rc from side wall-to-side wall (12, 13).

Although a preferred embodiment of the invention has been specifically illustrated and described herein, it is to be understood that minor variations may be made in the apparatus without departing from the spirit and scope of the invention, as defined by the appended claims.

What is claimed is:

1. A display door assembly comprising a product compartment access opening defined by a frame, a product compartment access door, means for effecting movement of said product compartment access door between a first closed position and a second open position respectively closing and opening said product compartment access opening, said frame including a raceway chamber adapted to house an electrical component, and said frame including an opening for accessing said raceway chamber from a warm side of the door assembly when said product compartment access door is in the first closed position thereof.

2. The display door assembly as defined in claim 1 including an access cover for closing and opening said raceway chamber access opening at respective first closed and second open positions.

3. The display door assembly as defined in claim 1 including an access cover for closing and opening said raceway chamber access opening at respective first closed and second open positions, and said raceway chamber access cover can be opened and closed when said product compartment access door is in the first closed position thereof.

4. The display door assembly as defined in claim 1 including means for securing said raceway chamber access cover in closed relationship to said raceway chamber access opening.

5. The display door assembly as defined in claim 1 wherein said raceway chamber access opening opens in a direction toward a warm side of said product compartment access door.

6. The display door assembly as defined in claim 1 including an access cover for closing and opening said raceway chamber access opening at respective first closed and second open positions, and means for pivotally mounting said raceway chamber access cover for pivotal movement between said raceway chamber access cover first and second positions respectively closing and opening said raceway chamber access opening.

7. The display door assembly as defined in claim 1 including an access cover for closing and opening said raceway chamber access opening at respective first closed and second open positions, means for securing said raceway chamber access cover in closed relationship to said raceway chamber access opening, a space between said frame and said product compartment access door, and said securing means is accessible through said space.

8. The display door assembly as defined in claim 1 including an access cover for closing and opening said raceway chamber access opening at respective first closed and second open positions, said raceway chamber access opening includes spaced elongated edge portions respectively adjacent and remote from said product compartment access door, said raceway chamber access cover in the closed position thereof substantially spans said spaced elongated edge portions, means at one of said spaced elongated edge portions for effecting movement of said raceway chamber access cover between said raceway chamber access cover closed and open positions, and means at another of said spaced elongated edge portions for securing said raceway chamber access cover in the closed position thereof.

9. The display door assembly as defined in claim 1 including an access cover for closing and opening said raceway chamber access opening at respective first closed and second open positions, said raceway chamber access opening includes spaced elongated edge portions respectively adjacent and remote from said product compartment access door, said raceway chamber access cover in the closed position thereof substantially spans said spaced elongated edge portions, means at said remote elongated edge portion for effecting movement of said raceway chamber access cover between said raceway chamber access cover closed and open positions, and means at said adjacent elongated edge portion for securing said raceway chamber access cover in the closed position thereof.

10. The display door assembly as defined in claim 1 including an access cover for closing and opening said raceway chamber access opening at respective first closed and second open positions, said raceway chamber access opening includes spaced elongated edge portions respectively adjacent and remote from said product compartment access door, said raceway chamber access cover in the closed position thereof substantially spans said spaced elongated edge portions, means at one of said spaced elongated edge portions for effecting movement of said raceway chamber access cover between raceway chamber access cover said closed and open positions, means at another of said spaced elongated edge portions for securing said raceway chamber access cover in the closed position thereof, and said raceway chamber access cover movement effecting means effects pivotal movement thereof.

11. The display door assembly as defined in claim 1 including an access cover for closing and opening said raceway chamber access opening at respective first closed and second open positions, said raceway chamber access opening includes spaced elongated edge portions respectively adjacent and remote from said product compartment access door, said raceway chamber access cover in the closed position thereof substantially spans said spaced elongated edge portions, means at said remote elongated edge portion for effecting movement of said raceway chamber access cover between said raceway chamber access cover closed and open positions, means at said adjacent elongated edge portion for securing said raceway chamber access cover in the closed position thereof, and said raceway chamber access cover movement effecting means effects pivotal movement thereof.

12. The display door assembly as defined in claim 1 including an access cover for closing and opening said raceway chamber access opening at respective first closed and second open positions, means for effecting movement of said raceway chamber access cover between said closed and open positions.

13. The display door assembly as defined in claim 1 including an access cover for closing and opening said raceway chamber access opening at respective first closed and second open positions, means for effecting movement of said raceway chamber access cover between said closed and open positions, and said raceway chamber access cover movement effecting means effects pivotal movement thereof.

14. The display door assembly as defined in claim 1 including an access cover for closing and opening said raceway chamber access opening at respective first closed and second open positions, said raceway chamber access opening includes spaced elongated edge portions respectively adjacent and remote from said product compartment access door, said raceway chamber access cover in the closed position thereof substantially spans said spaced elongated edge portions, means at one of said spaced elongated edge portions for effecting movement of said raceway chamber access cover between said raceway chamber access cover closed and open positions, means at another of said spaced elongated edge portions for securing said raceway chamber access cover in the closed position thereof, said raceway chamber access cover movement effecting means effects pivotal movement thereof, and said raceway chamber access cover pivotal movement effecting means includes a hook portion of one of said last-mentioned cover and said spaced elongated edge portions in hooking engagement with the other of said last-mentioned cover and said spaced elongated edge portions.

15. The display door assembly as defined in claim 1 including an access cover for closing and opening said raceway chamber access opening at respective first closed and second open positions, said raceway chamber access opening includes spaced elongated edge portions respectively adjacent and remote from said product compartment access door, said raceway chamber access cover in the closed position thereof substantially spans said spaced elongated edge portions, means at one of said spaced elongated edge portions for effecting movement of said raceway chamber access cover between said raceway chamber access cover closed and open positions, means at another of said spaced elongated edge portions for securing said raceway chamber access cover in the closed position thereof, said raceway chamber access cover movement effecting means effects pivotal movement thereof, and said raceway chamber access cover pivotal movement effecting means includes a hook portion of one of said last-mentioned cover and said spaced elongated edge portions in hooking engagement with the other of said last-mentioned cover and said spaced remote elongated edge portion.

16. The display door as defined in claim 1 including means in said raceway chamber for removably securing an electrical component therein.

17. The display door as defined in claim 1 including means in said raceway chamber for removably securing an electric ballast therein.

18. The display door assembly as defined in claim 1 including an access cover for closing and opening said raceway chamber access opening at respective first closed and second open positions, said raceway chamber access opening includes spaced elongated edge portions respectively adjacent and remote from said product compartment access door, said raceway chamber access cover in the closed position thereof substantially spans said spaced elongated edge portions, said raceway compartment access cover has a pair of elongated relatively spaced flanges projecting into said raceway chamber opening, and said flanges are located one each adjacent said raceway chamber access opening elongated edge portions.

19. The display door assembly as defined in claim 1 including an access cover for closing and opening said raceway chamber access opening at respective first closed and second open positions, said raceway chamber access opening includes spaced elongated edge portions respectively adjacent and remote from said product compartment access door, said raceway chamber access cover in the closed position thereof substantially spans said spaced elongated edge portions, said raceway compartment access cover has a pair of elongated relatively spaced flanges projecting into said raceway chamber access opening, said flanges being located one each adjacent said raceway chamber access opening elongated edge portions, one of said pair of flanges terminates in a latching lip directed toward a lower edge of said raceway chamber opening, and means for latching with said latching lip to latch said raceway chamber access cover in closed relationship to said raceway chamber front opening.

20. The display door assembly as defined in claim 1 including an electrical component housed in said raceway chamber.

21. The display door assembly as defined in claim 1 including an electrical component housed in said raceway chamber, and said electrical component is an electric ballast.

22. The display door assembly as defined in claim 1 wherein a first vertical plane through an innermost surface of said product compartment access door defines a cold side thereof, said frame includes an upper substantially horizontally disposed frame portion peripherally outboard of said compartment access door, said upper substantially horizontally disposed frame portion defines said raceway chamber, said raceway chamber access opening provides access relative to said raceway chamber from a warm side of the door assembly, and a second vertical plane through said raceway chamber access opening being located spaced from said first vertical plane toward the warm side of said product compartment access door.

23. The display door assembly as defined in claim 2 wherein a first vertical plane through an innermost surface of said product compartment access door defines a cold side thereof, said frame includes an upper substantially horizontally disposed frame portion peripherally outboard of said compartment access door, said upper substantially horizontally disposed frame portion defines said raceway chamber, said raceway chamber access opening provides access relative to said raceway chamber from a warm side of the door assembly, and a second vertical plane through said raceway chamber access opening being located spaced from said first vertical plane toward the warm side of said product compartment access door.

24. The display door assembly as defined in claim 2 wherein said raceway chamber access opening opens in a direction toward a warm side of said product compartment access door.

25. The display door assembly as defined in claim 2 including an access cover for closing and opening said raceway chamber access opening at respective first closed and second open positions, means for securing said raceway chamber access cover in closed relationship to said raceway chamber access opening, a space between said frame and said product compartment access door, and said securing means is accessible through said space.

26. The display door as defined in claim 2 including means in said raceway chamber for removably securing an electrical component therein.

27. The display door as defined in claim 2 including means in said raceway chamber for removably securing an electric ballast therein.

28. The display door as defined in claim 2 including means in said raceway chamber for removably securing an electric ballast therein.

29. The display door as defined in claim 5 including means in said raceway chamber for removably securing an electric ballast therein.

30. A display door assembly comprising a product compartment access opening defined by a frame, a product compartment access door, means for effecting movement of said product compartment access door between a first closed position and a second open position respectively closing and opening said product compartment access opening, said frame including a raceway chamber adapted to house an electrical component, said frame including an opening for accessing said raceway chamber from a warm side of the door assembly, a first vertical plane through an innermost surface of said product compartment access door defining a cold side thereof, said frame includes an upper substantially horizontally disposed frame portion peripherally outboard of said compartment access door, said upper substantially horizontally disposed frame portion defines said raceway chamber, said raceway chamber access opening provides access relative to said raceway chamber from a warm side of the door assembly, and a second vertical plane through said raceway chamber access opening being located spaced from said first vertical plane toward the warm side of said product compartment access door.

31. The display door assembly as defined in claim 30 including an access cover for closing and opening said raceway chamber access opening at respective first closed and second open positions.

32. The display door assembly as defined in claim 30 wherein said raceway chamber access opening opens in a direction toward a warm side of said product compartment access door.

33. The display door assembly as defined in claim 30 including an access cover for closing and opening said raceway chamber access opening at respective first closed and second open positions, means for securing said raceway chamber access cover in closed relationship to said raceway chamber access opening, a space between said frame and said product compartment access door, and said securing means is accessible through said space.

34. The display door as defined in claim 30 including means in said raceway chamber for removably securing an electrical component therein.

35. The display door as defined in claim 30 including means in said raceway chamber for removably securing an electric ballast therein.

36. The display door as defined in claim 32 including means in said raceway chamber for removably securing an electric ballast therein.

37. The display door as defined in claim 33 including means in said raceway chamber for removably securing an electric ballast therein.
